(19) United States
(12) Patent Application Publication
(10) Pub. No.: US 2011/0225020 A1
(43) Pub. Date: Sep. 15, 2011

(54) METHODOLOGY FOR IMPROVING A MERCHANT ACQUIRING LINE OF BUSINESS

(75) Inventor: Michael J. Tolle, Larchmont, NY (US)

(73) Assignee: MASTERCARD INTERNATIONAL, INC., Purchase, NY (US)

(21) Appl. No.: 12/721,188

(22) Filed: Mar. 10, 2010

(51) Int. Cl. G06Q 10/00; G06Q 30/00

(52) U.S. Cl. 705/7.29

(57) ABSTRACT

A methodology for a merchant acquirer to leverage its own internal data for analysis purposes whereby it analyzes data associated with its issuing line of business to provide information for use in promoting/retaining business within its acquiring line of business.

### BACKGROUND OF THE INVENTION

The present invention relates to a merchant acquirer's ability to leverage its own internal data for analysis purposes and, more particularly, to a methodology for utilizing data associated with its issuing line of business to promote/retain business within its acquiring line of business.

For example, one skilled in the art will appreciate that many larger banking entities have both an issuing line of business (ILOB) in which they issue credit/debit cards to their primarily retail banking customers, as well as an acquiring line of business (ALOB) in which they function as a merchant acquirer and commercial bank to handle the credit/debit based transactions associated with a particular retail merchant. Stated differently, a retail merchant who desires to accept various consumer credit/debit cards in its business activities is inherently required to have an authorized bank function as its merchant acquirer. The banking entity provides the retail merchant with the necessary equipment/services to allow the retail merchant to authorize and receive payments from its customers via credit/debit cards.

The fees and relationship generated by the ALOB of a merchant acquirer can be an important part of the overall commercial business services of such entity. As with any other business model, it is important for a merchant acquirer to continually improve its understanding of its customer base, namely why new merchants choose its ALOB, why existing merchants switch from a competitor's ALOB to its ALOB, what types of businesses are more likely to go out of business and no longer need services, why other merchants would switch from its ALOB to a competitor's ALOB, and why the merchant acquirer's most loyal merchants choose to continue to do business with its ALOB.

Moreover, a proper business model should be continuously concerned with retention of customers, effectiveness of various sales channels, appropriate pricing, impacts of pricing changes, alignment with risks, recognition of market trends and segment market share. The underlying causes of merchant retention and attrition can vary by merchant industry, size, geography, and years established, in addition to the ALOB performance.

It will be recognized by those skilled in the art that current analysis tools, which are typically limited to an analysis of data compiled from a merchant acquirer's acquiring line of business, can provide only limited input into the foregoing mentioned areas. Other means of obtaining this data (e.g., manually collecting stated causes for customers starting/stopping services, purchasing bankruptcy data from commercial databases) have been shown to be too expensive within the accepted pricing schemes used in the marketplace, are likely to offer only limited insight and/or do not sufficiently meet ALOB decision-making needs.

There is therefore a need in the art for a new methodology which allows a merchant acquirer to access more extensive data in a more sophisticated manner whereby it can more effectively and efficiently analyze, grow and manage underlying profitability of its ALOB.

### SUMMARY OF THE INVENTION

The present invention, which addresses the needs for the prior art, relates to a method for a merchant acquirer to identify business opportunities within a card-based transaction network. The merchant acquirer has both an issuing line of business and an acquiring line of business. The method includes the steps of 1) correlating a first set of data associated with a plurality of cardholders belonging to the issuing line of business to a second set of data associated with a plurality of merchants belonging to the acquiring line of business of the merchant acquirer; 2) extrapolating the correlated data to estimate the size of a selected group of non-acquired merchants; and 3) analyzing the criteria to identify market opportunities among the selected group of non-acquired merchants.

The present invention further relates to a method for a merchant acquirer to access risks associated with a merchant seeking to participation within a card-based transaction network. The method includes the steps of 1) analyzing data associated with an issuing line of business of the merchant acquirer to identify market data associated with the merchant prior to a time T₀; and 2) utilizing the market data to assign a risk factor to the merchant prior to acceptance by the merchant acquirer.

The present invention further relates to a method for a merchant acquirer to improve business performance within a card-based transaction network. The merchant acquirer has both an issuing line of business and an acquiring line of business. The method includes the steps of 1) analyzing data associated with the issuing line of business to identify spending trends in the marketplace; and 2) directing business recourses of the merchant acquirer in accordance with the spending trends.

Finally, the present invention relates to a method of measuring merchant retention by a merchant acquirer within a card-based transaction network. The merchant acquirer has both an issuing line of business and an acquiring line of business. The method includes the steps of 1) identifying a merchant within the acquiring line of business which has ceased doing business with the merchant acquirer as of a time T₁; 2) analyzing data associated with an issuing line of business of the merchant acquirer to identify market data associated with the merchant subsequent to said time T₁; and 3) analyzing the market data to determine whether the merchant has ceased operation or is associated with a new merchant acquirer.

As a result, the present invention provides a new methodology which allows a merchant acquirer to access the data associated with its ILOB in a manner which allows it to analyze, grow and/or manage its ongoing ALOB.

### BRIEF DESCRIPTION OF THE DRAWINGS

FIG. 1 is a schematical view of a card-based transaction network;

FIG. 2 is a diagram depicting the intersecting lines of business of a merchant acquirer within a merchant universe; and

FIG. 3 is a schematical view showing the tool of the present invention cooperating with a computing device associated with a merchant acquirer.

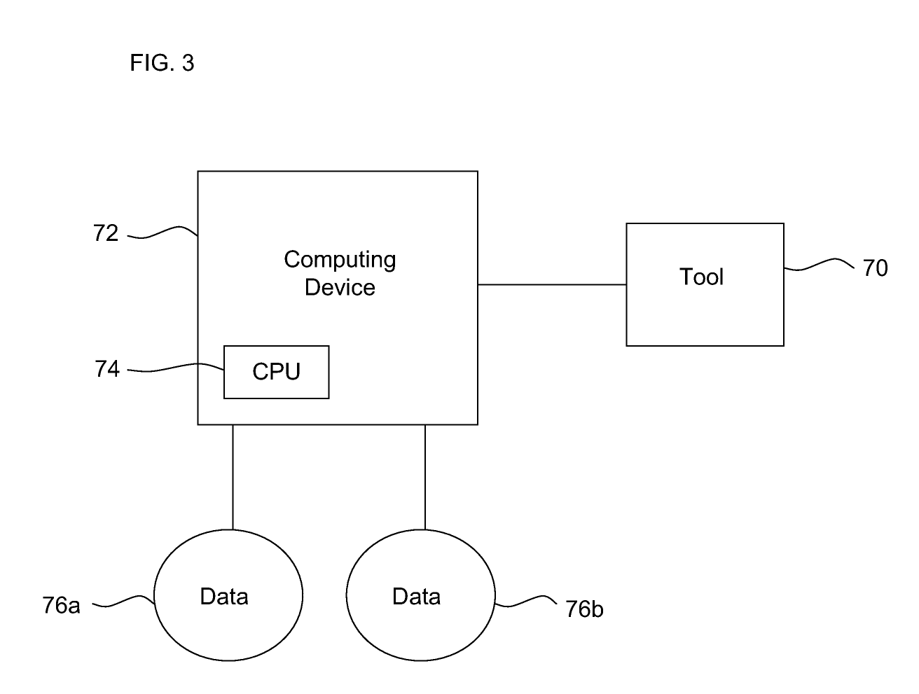

### DETAILED DESCRIPTION OF THE INVENTION

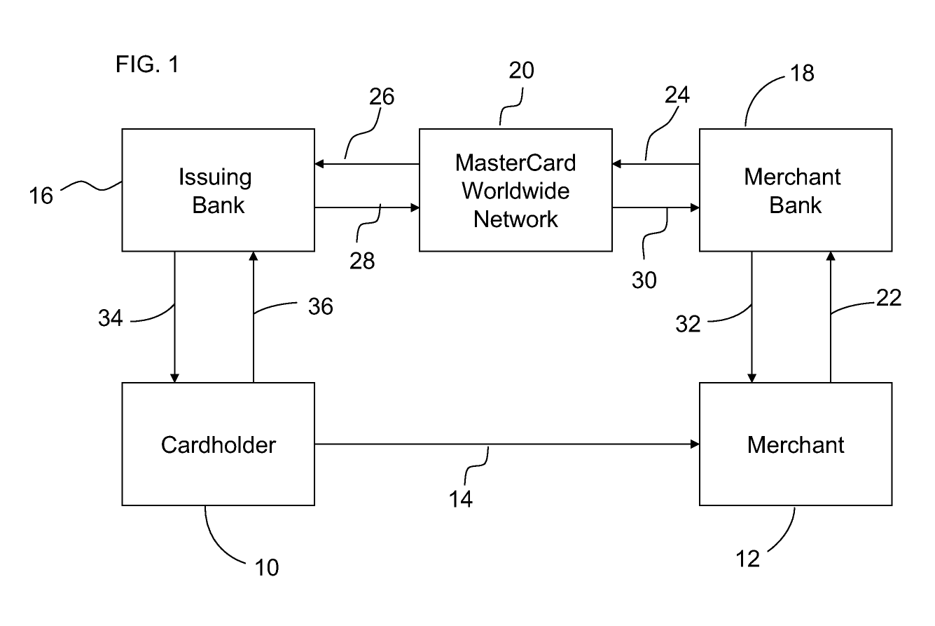

Consumer card-based payment networks are known in the art. One such payment network is the MasterCard Worldwide Network, which is described with reference to FIG. 1.

In a typical transaction, a cardholder 10 presents his credit/debit card to a merchant 12 for the purchase of goods and/or services. This transaction is indicated by arrow 14. It will be understood that prior to the occurrence of transaction 14, cardholder 10 was issued a card by issuing bank 16. Moreover, it will be understood that merchant 12 established a relationship with a merchant acquirer, i.e. merchant bank 18, thereby allowing merchant 12 to receive credit/debit cards as payment for goods and/or services. The merchant acquirers and issuing banks may participate in various payment networks, including MasterCard Worldwide Network 20.

After presentation of a card to merchant 12 by cardholder 10, merchant 12 sends an authorization request (indicated by arrow 22) to bank 18. In turn, bank 18 communicates with network 20 (indicated by arrow 24), and network 20 communicates with the issuing bank 16 (indicated by arrow 26) to determine whether the cardholder is authorized to make the transaction in question. An approval or disapproval of the authorization request is thereafter transmitted back to merchant 12 (indicated by arrows 28, 30 and 32). Merchant 12 thereafter either completes or cancels the transaction based upon the response to the authorization request.

If transaction 14 is approved, the transaction amount will be sent from issuing bank 16 through network 20 to bank 18. This transaction amount, minus certain fees charged by both network 20 and bank 18, will thereafter be deposited within a bank account belonging to merchant 12. Issuing bank 16 thereafter bills cardholder 10 (indicated by arrow 34) for the amount of such transaction, and cardholder 10 follows by a submission of payment(s) (as indicated by arrow 36) to issuing bank 16. This submission of payment(s) (as indicated by arrow 36) by cardholder 10 may be automated (e.g., in the case of debit transactions), may be initiated by the cardholder for the exact amount matching costs of purchases during the statement period (e.g., charge cards or credit balances paid in full), and/or may be submitted (in part or in whole) over a period of time that thereby reflects the costs of the purchases plus financing charges agreed upon beforehand between the cardholder and the cardholder's issuing bank (e.g., revolving credit balances.)

As mentioned, certain banking entities operate (e.g., staff, processing systems, financial liquidity, governmental and brand licenses) both an ILOB in which they issue credit/debit cards primarily to their retail banking customers and an ALOB in which they function as commercial bank to manage authorization, clearing, and settlement of a merchant's payments acceptance. Payment acceptance including, but not limited to, cardholders presenting credit, debit, private label, commercial, and prepaid cards. Within the organizational structure of a typical large financial institution/banking entity, a consumer-focused cardholder ILOB is inherently different and likely operating totally independently from the merchant-focused ALOB—many times operating under separate trade names. As a result of these material differences between separate lines of business (e.g., ILOB consumer financing focus, ALOB commercial services economic models, disparate technologies and processing platforms, etc.), both structural and organizational silos often exist between the ILOB and ALOB of a financial institution/banking entity.

It is to be noted that the above industry dynamics are not required for the application and/or novelty of the invention being described. These industry dynamics (i.e., ILOB versus ALOB operations) have been described herein to illustrate the disparate and segregated business processes, technological infrastructures, software applications, and management information systems that are structurally significant within the developed payments industry. It is the inherent structural segregation that creates both value and novelty within the proposed invention.

It is also to be noted that the constructs of the payment industry's ILOB and ALOB operations are not exhaustive reasons for the benefits of the proposed invention. For example, the extensive global consolidation within the banking industry is an additional material contributor to the line of business segregation.

Lastly, the inherent sensitivity of personal cardholder data and card number information being processed and stored within the ILOB and ALOB, along with the associated regulations and payments industry rules, necessitate discrete systems and accountabilities. One skilled in the art will appreciate and understand that the present invention does not require the exchanging of sensitive/regulated cardholder data. Rather only the industry mandated firmographic merchant location information—required for the authorization, clearings, and settlement of cardholder transactions—is processed/needed by the present invention.

It has been discovered herein that a banking entity having both an ILOB and an ALOB can leverage the data associated with its ILOB to improve its ALOB operations and profitabillity. As will be recognized by those skilled in the art, the fees generated by the ALOB of a merchant acquirer can be an important part of the business model of such entity. The data which is leveraged from the ILOB can provide insight into the merchant acquirer's customer base, namely why new customers have begun (i.e., merchant acquisition) or existing customers have left (i.e., merchant attrition.) Moreover, such leveraged data can assist in materially improving the overall customer loyalty, market-based pricing, and adjustments for risk levels that vary significantly by customer, industry, and geography. Finally, the data leveraged by the tool can provide currently unavailable and therefore highly valuable information regarding market trends and ALOB market share. Inasmuch as the invention described herein utilizes data within the confines of a particular merchant acquirer, marketplace benchmarking (whether through self reporting or third-party research) is not a required capability.

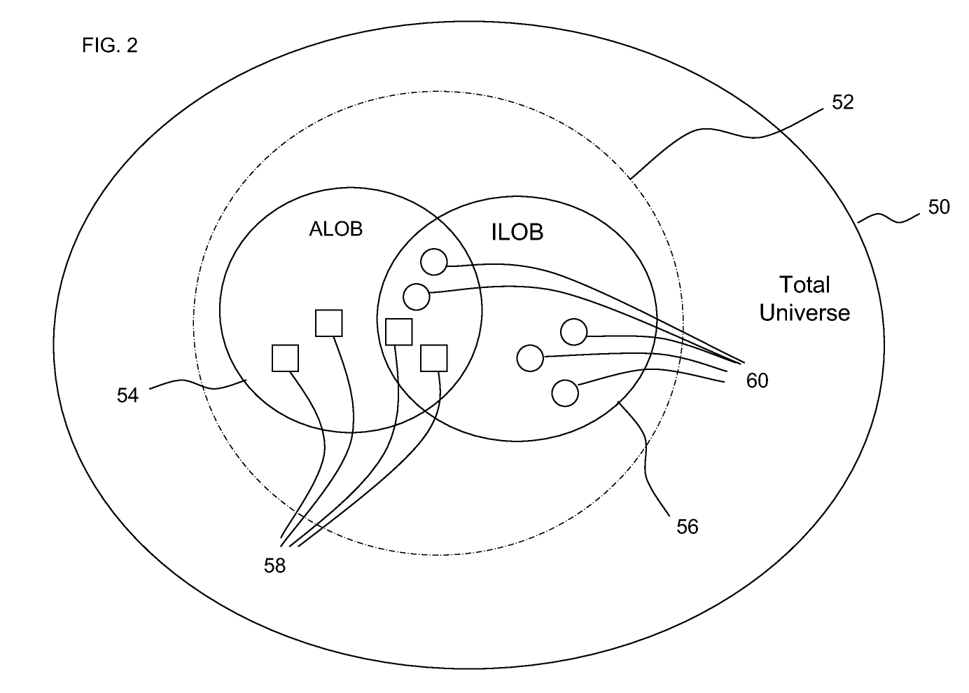

Referring now to FIG. 2, a total universe 50 is graphically depicted. Total universe 50 can represent a particular segment of a business market, a specific type of retailer, a specific geographic region, etc. Within the total universe 50, a merchant acquirer, i.e., bank 52, may have an ALOB 54 and an ILOB 56. As graphically depicted in FIG. 2, the ILOB cardholder footprint is highly likely to expand materially beyond the ALOB, and encompass major portions of the total merchant universe—incremental merchants, industries, geographies—not encompassed by the ALOB 54. In one preferred embodiment, ALOB 54 is made up of a plurality of individual merchants 58, while ILOB 56 is made up of a plurality of individual cardholders 60.

The present invention is preferably capable of recognizing and understanding the value and significance of the transaction data gathered by the cardholders of ILOB 56 versus that of the merchants of ALOB 54. For clarity, sizable ILOB cardholder portfolios are taking a very broad and ongoing snapshot of the overall card payments marketplace. This in turn results in very large and highly statistically significant data sets. These data sets reflect disperse unconstrained consumer behavior over discrete but continuous periods of time and are, in concept and in unique application, capable of acting as merchant location sampling mechanisms of heretofore unprecedented scale and statistical significance. The present invention allows these data sets to be viewed/analyzed in new and novel manners.

In one preferred embodiment, a quantifiable portion of the transactions of cardholder 60 will be made at merchants within ALOB 54, while other quantifiable portions of the transactions of those same cardholders will be made at merchants not participating within ALOB 54.

The present invention provides a data analysis tool 70 for leveraging the data associated with ILOB 56 of bank 52 to benefit ALOB 54. Tool 70 is configured to communicate with a computing device 72. Computing device 72 can be a mainframe, personal computer (PC), laptop computer, workstation, handheld device, such as a PDA, or the like. Computing device 72 can include one or more controllers or processors, such as a central processing unit (CPU 74). Computing device 72 also communicates with one or more data storage devices, e.g., storage 76a, 76b. Storage 76a, 76b can include computer readable medium technologies, such as a floppy drive, hard drive, tape drive, flash drive, optical drive, read only memory (ROM), random access memory (RAM), and the like. In one preferred embodiment, storage 76a receives and stores data from ALOB 54, while storage 76b receives and stores data from ILOB 56. Of course, storage 76a, 76b could be combined into a single storage device, and could be located internally within computing device 72 or externally as shown. Moreover, computing device 72 and storage 76a, 76b could both be located at bank 52, could both be located at a remote location, or could be located at separate locations.

Tool 70 of the present invention is configured to analyze the data associated with ILOB 56, and to correlate such data to the data associated with ALOB 54. In one preferred embodiment, tool 70 performs statistical analyses to correlate the data between these two lines of business. Tool 70 can include hardware and/or software, and is preferably operated and/or run by CPU 74. In particular, CPU 74 can execute instructions included in tool 70 to perform the steps described herein.

In its simplest form, the mentioned correlation can be established by comparing the total volume of card payments processed by a particular merchant belonging to ALOB 54 for time period T₀ to T₁ to the total volume of card payments made by cardholders 60 at that same merchant for that same time period T₀ to T₁. For example, if the total ALOB activity at the mentioned merchant is $100, while the total ILOB activity at such merchant is $25, a 4:1 correlation may be established by tool 70.

Tool 70 may also quantify ILOB 56 cardholder activity of $25 for the same time period T₀ to T₁ at a merchant not yet acquired by ALOB 54, e.g., a hardware merchant. Tool 70 computes, derives, and stores several data assets. One such data asset is the existence/location of the hardware merchant, while another data asset is the extrapolated size of the merchant ($100 in payments acceptance volume for the same time period T₀ to T₁—based on the previously determined 4:1 correlation ratio). Other attributes may also be derived and stored, e.g., whether this merchant ever belonged to ALOB 54, when it first came into existence, and relative size if it were to later become a merchant serviced by ALOB 54.

Tool 70 may also compute, derive, and store for the same time period the correlated sizes of all the non-acquired hardware merchants of bank 52 by geography (e.g. ZIP, County, MSA, DMA, State, Region Country) so that a market penetration of the ALOB 54 of bank 52 can be determined, both in terms of market share of hardware merchant locations and market share of hardware merchant payment acceptance volume. A sample metric, determined through the application of tool 70, may provide that the ALOB 54 of bank 52 has 20% of hardware merchant locations, but that it has 40% of hardware merchant payment acceptance.

In one embodiment, tool 70 is able to identify when ILOB 56 first saw or last saw a transaction at a merchant location. This information is then used in the retention and attrition model to determine if a merchant switched to ALOB 54, just started their business, just started accepting card payments, switched away from ALOB 54, stopped accepting card payments, or went out of business.

In another embodiment, tool 70 is able to differentiate—within a statistical level of certainty—between starting/stopping acceptance and opening/closing of a merchant by the type of merchant, the type of location for the merchant, and/or whether another merchant had ILOB 56 transaction activity before or after payment acceptance visibility was gained or lost. For example, if a hardware merchant location stops transacting with the cardholders of ILOB 56 and two months later a wine merchant starts transacting at the same physical location (also correlating against probabilities within the known universe of similar situations within ALOB 54), then tool 70 can derive and store the closure of the hardware merchant location and the opening of the wine merchant location.

In one preferred embodiment, tool 70 can normalize for changes in the size/density of the ILOB cardholder portfolio across time, utilize much more robust statistical methods for extrapolation of non-ALOB merchants, and cross test models against known merchant universes to fine tune algorithms and derive statistical probabilities.

The extrapolation exemplified above is particularly useful to ALOB 54 in that it allows ALOB 54 to identify and target market segments and/or geographic regions for penetration/expansion.

In addition to identifying market segments for penetration/expansion, tool 70 of the present invention allows bank 52 to leverage the data associated with ILOB 56 to improve the performance of ALOB 54. More particularly, this data allows the bank to both “look back” and “look forward.” As will be recognized by those skilled in the art, the ability to “look back” allows a business to assess its performance in terms of how well it retains merchants 58. Bank 52 can determine from the records associated with ALOB 54 which merchants have been acquired, which merchants have left, and which merchants have remained with the bank. However, what bank 52 does not know is why particular merchants have left, or why others have been acquired by the bank.

With respect to a merchant who has left, bank 52 can analyze the data associated with ILOB 56 to determine whether any of cardholders 60 are still transacting business with such merchant. If the size of the ILOB is sufficiently large, it is likely that at least some of cardholders 60 associated with ILOB 56 are doing business with that particular merchant as part of their normal spending habits. If such spending data does exist following the departure of the merchant from bank 52, then bank 52 will know that the merchant left its bank and is now doing business with another bank. Other the hand, if there is no additional spending activity associated with that particular merchant following that merchant's departure from bank 52, then it is likely that such merchant has ceased operating. It will be recognized that such information is valuable to the bank. The fact that a merchant left one bank to do business with a second bank may reflect on the first bank's customer service, fee schedule or other such factors. If however, the merchant simply went out of business, then this does not reflect negatively on the bank's business model.

With respect to looking forward, tool 70 of the present invention provides several significant advantages in this regard. More particularly, the data associated with ILOB 56 can be used to identify changes and/or trends in spending patterns. For example, if the data from ILOB 56 indicates that cardholders 60 are spending less money in certain segments of the marketplace, then ALOB 54 may decide that these segments are not as desirable and/or not worth spending additional time/money to pursue. Of course, if the ILOB data indicates that spending is increasing in a particular market segment and/or geographic region, then ALOB 54 may decide to devote additional resources to capture this additional spending.

The data associated with ILOB 56 can also assist bank 52 when it determines the pricing fee structure for a particular merchant or merchants. For example, when a particular merchant approaches the bank, the bank can analyze the data associated with ILOB 56 to determine how long this particular merchant has been in business. This information is useful in that many businesses have a lifespan. Bank 52 may want to price its services differently depending on whether the business is at the beginning of its lifespan or near the end of its lifespan. Moreover, the present invention will allow bank 52 to determine whether this particular merchant has stayed with its prior bank for a significant period of time, or is in the habit of changing banks. Again, this information will guide bank 52 in determining the proper fees structure for this merchant. In other situations, an analysis of the data of ILOB 56 may indicate that this particular merchant has been associated with fraudulent transactions in the past and/or is associated with a retail location which has experienced significant turnover. Again, this type of information will assist bank 52 in determining whether it chooses to due business with a particular merchant and, if so, how to price its services commensurate with the risk associated with that particular merchant.

Thus, the bank's ILOB identifies which merchant locations are continuously occurring transactions on a month-to-month basis. When conducted over a period of time, the bank's ILOB will follow a particular merchant or merchant location (e.g. a full service restaurant) from cradle to grave. The month prior to a merchant's creation would show no cardholder transactions, as would the month after the merchant ceases operation. In this way, the banks ILOB is used to measure merchant retention and attrition for the merchants that are not within the banks ALOB. This data can also be compared to the bank's ALOB to determine merchant retention/attrition performance.

As discussed hereinabove, the correlation/extrapolation steps can be used to determine the relative size of a non-acquired merchant. This information is useful in that there is relationship between a merchant's size and the relatively retention/attrition performance in the marketplace. More particularly, this information can be used to determine performance and likelihood that X % of merchants of this size, in this industry and for this country, will attrite, or y % of merchants will start acceptance.

One skilled in the art will also appreciate that the above exemplifications of how bank 52 may leverage its combined ILOB and ALOB assets—for the benefit of improving merchant retention—may be structured so as to leverage the overall benefits to Bank 52. Alternatively, tool 70 may be configured such that a group of entities (e.g., ILOBs, ALOBs, etc.) could achieve similar benefits independently, or through third-party participants utilizing tool 70.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included in the scope of the present invention.

What is claimed is:

1. A method for a merchant acquirer to identify business opportunities within a card-based transaction network, said merchant acquirer having both an issuing line of business and an acquiring line of business, the method comprising:
correlating a first set of data associated with a plurality of cardholders belonging to said issuing line of business to a second set of data associated with a plurality of merchants belonging to said acquiring line of business of said merchant acquirer;
extrapolating said correlated data to estimate the size of a selected group of non-acquired merchants; and
analyzing said criteria to identify market opportunities among said selected group of non-acquired merchants.

2. The method according to claim 1, further comprising the step of:
collecting said first and second sets of data.

3. The method according to claim 2, wherein said correlating step is accomplished via a statistical analysis process.

4. The method according to claim 3, further comprising the step of:
determining an average attrition rate for businesses within a selected business segment based on size; and
wherein said analyzing step includes the further step of identifying a subset of said non-acquired merchants based upon said estimated size which can be predicted to have an attrition rate less than a predetermined value.

5. A method for a merchant acquirer to assess risk associated with a merchant seeking participation within a card-based transaction network, comprising:
analyzing data associated with an issuing line of business of said merchant acquirer to identify market data associated with said merchant prior to a time T₀; and
utilizing said market data to assign a risk factor to said merchant prior to acceptance by said merchant acquirer.

6. The method according to claim 5, further comprising the steps of:
estimating the length of time Tₒₚ that said merchant has been in operation;
estimating the average lifespan for businesses in the line of business of said merchant;
comparing said time Tₒₚ to said estimated lifespan to determine said risk factor.

7. The method according to claim 5, further comprising the steps of:
analyzing said market data to identify information concerning former merchant acquirers associated with said merchant over a preselected period of time prior to time T₀;
utilizing said information to determine said risk factor.

8. The method according to claim 5, further comprising the steps of:
analyzing said market data to identify negative information associated with said merchant prior to time T₀;
utilizing said negative information to determine said risk factor.

9. A method for a merchant acquirer to improve business performance within a card-based transaction network, said merchant acquirer having both an issuing line of business and an acquiring line of business, the method comprising:
analyzing data associated with said issuing line of business to identify spending trends in the marketplace; and
directing business recourses of said merchant acquirer in accordance with said spending trends.

10. A method of measuring merchant retention by a merchant acquirer within a card-based transaction network, said merchant acquirer having both an issuing line of business and an acquiring line of business, the method comprising:
identifying a merchant within said acquiring line of business which has ceased doing business with said merchant acquirer as of a time T₁;
analyzing data associated with an issuing line of business of said merchant acquirer to identify market data associated with said merchant subsequent to said time T₁;
analyzing said market data to determine whether said merchant has ceased operation or is associated with a new merchant acquirer.
